(19) United States
(12) Patent Application Publication
(10) Pub. No.: US 2021/0247122 A1
(43) Pub. Date: Aug. 12, 2021

(54) COLD STORAGE PACK AND PACKAGING CONTAINER, AND METHOD OF TRANSPORTING OBJECT AT LOW TEMPERATURE

(71) Applicant: SHARP KABUSHIKI KAISHA, Sakai City, Osaka (JP)

(72) Inventors: KYOHEI SEZUKURI, Sakai City, Osaka (JP); YUKA UTSUMI, Sakai City, Osaka (JP); MASAKAZU KAMURA, Sakai City, Osaka (JP); DAISUKE SHINOZAKI, Sakai City, Osaka (JP)

(21) Appl. No.: 16/972,562

(22) PCT Filed: May 27, 2019
(86) PCT No.: PCT/JP2019/020832

§ 371 Date: Dec. 4, 2020

(30) Foreign Application Priority Data
Jun. 8, 2018 (JP) 2018-110352

(51) Int. Cl. F25D 3/08; F28D 20/02; B65D 81/18

(52) U.S. Cl. CPC F25D 3/08; B65D 81/18; F28D 20/02

(57) ABSTRACT

A cold storage pack includes: heat exchange sections arranged in a first direction and in a second direction intersecting with the first direction; and a connecting section connecting the heat exchange sections that are adjacent, wherein the heat exchange sections each include: a latent heat storage material having a melting point lower than room temperature; and a container section having an internal space containing the latent heat storage material in a liquid-tight manner, the connecting section includes: an easy cutting section that is cuttable between the heat exchange sections; a frame-shaped section surrounding the heat exchange sections; a first connecting section extending between the heat exchange sections in the first direction; and a second connecting section extending between the heat exchange sections in the second direction, and the easy cutting section is continuous at least from an outer periphery of the frame-shaped section partway through the first connecting section.

### TECHNICAL FIELD

The present invention relates to cold storage packs and packaging containers and methods of transporting an object at low temperature.

The present application claims priority to Japanese Patent Application, Tokugan, No. 2018-110352 filed in Japan on Jun. 8, 2018, which is incorporated herein by reference in its entirety.

### BACKGROUND ART

There has been an increasing need in logistics to transport articles that require rigorous temperature control. Examples of such articles include medicine, cells, blood and other like specimens, and food. As an example, medicine and blood need to be transported at controlled temperature in a range of 2 to 8° C. To respond to such a need, isothermal transport technology is necessary that can simultaneously transport goods and maintain them in a specific temperature range.

Patent Literature 1 discloses a method of cool delivery of bottled drinks to individual homes. The invention described in Patent Literature 1 involves the use, as a cold storage member, of a divided-package cooling sheet including: sealing portions; and sachets, each containing a water-absorbing resin, between the sealing portions. This cooling sheet is placed inside an outer bag and bent along some or all of the sealing portions in a suitable manner to cool the bottled drink by covering the top or side of the bottle.

Patent Literature 2 discloses a thermal storage pack. In the invention described in Patent Literature 2, the thermal storage pack includes: a portion containing a thermal storage medium in the main body of the pack; and a portion containing a medium composition. The portion containing a thermal storage medium is liquid at or above a prescribed temperature and solid at or below the prescribed temperature. The medium composition is semi-solid or solid at or above the prescribed temperature and semi-liquid or as viscous as a liquid at or below the prescribed temperature.

When this thermal storage pack is cooled in a refrigerator starting at a temperature higher than or equal to the prescribed temperature down to or below the prescribed temperature, only the portion containing a thermal storage medium freezes, and the portion containing a medium composition remains semi-liquid or liquid. The thermal storage pack is hence capable of cooling an object with the medium composition being fitted to the surface of the object. This mechanism is described as enabling the thermal storage pack to efficiently cool the object.

### CITATION LIST

### Patent Literature

Patent Literature 1: Japanese Unexamined Patent Application Publication, Tokukaihei, No. 7-223677

Patent Literature 2: Japanese Unexamined Patent Application Publication, Tokukaihei, No. 10-234767

### SUMMARY OF INVENTION

### Technical Problem

The home delivery method disclosed in Patent Literature 1 however may leave parts of the bottle uncovered because when the cold storage member is frozen, the frozen portions have poor flexibility. In this situation, it would be difficult to restrain a heat flow to the bottled drink through the uncovered parts of the surface of the bottle.

It would be similarly difficult in the thermal storage pack disclosed in Patent Literature 2 to restrain a heat flow to the object through uncovered parts of the surface thereof.

It is hence concluded that these types of isothermal transport technology are yet to provide sufficient isothermal transport capability.

The present invention, in an aspect thereof, has been made in view of these issues and has an object to provide a cold storage pack, a packaging container, and a method of transporting an object at low temperature, each enabling isothermal transport without much labor and cost.

### Solution to Problem

To address the issues, the present invention, in an aspect thereof, provides a cold storage pack including: a plurality of heat exchange sections arranged in a first direction and in a second direction as in a matrix, the second direction intersecting with the first direction; and a connecting section connecting the plurality of heat exchange sections that are adjacent, wherein the heat exchange sections each include: a latent heat storage material having a melting point lower than room temperature; and a container section having an internal space containing the latent heat storage material in a liquid-tight manner, the connecting section includes: an easy cutting section that is cuttable between the plurality of heat exchange sections that are adjacent; a frame-shaped section surrounding a periphery of a whole of the plurality of heat exchange sections; a first connecting section extending between the plurality of heat exchange sections that are adjacent in the first direction; and a second connecting section extending between the plurality of heat exchange sections that are adjacent in the second direction, and the easy cutting section is continuous at least from an outer periphery of the frame-shaped section partway through the first connecting section.

In another aspect of the present invention, the easy cutting section may extend from one end of the first connecting section partway through the first connecting section and from the other end of the first connecting section partway through the first connecting section.

In yet another aspect of the present invention, the easy cutting section may extend continuously from one end of the first connecting section to the other end of the first connecting section.

In still another aspect of the present invention, the easy cutting section may extend from the outer periphery of the frame-shaped section partway through the second connecting section.

In yet still aspect of the present invention, the easy cutting section may extend from one end of the second connecting section partway through the second connecting section and from the other end of the second connecting section partway through the second connecting section.

In a further aspect of the present invention, the easy cutting section may extend continuously from one end of the second connecting section to the other end of the second connecting section.

In yet a further aspect of the present invention, the connecting section may include a reconnecting section in a location where the easy cutting section is provided, the reconnecting section having been configured to reconnect the connecting section cut along the easy cutting section.

The present invention, in still a further aspect thereof, provides a packaging container including: the cold storage pack enwrapping an object to be kept cold; and a container configured to contain the object and the cold storage pack.

The present invention, in yet still a further aspect thereof, provides a method of transporting the object to be kept cold by using the packaging container, the method including: cutting the easy cutting section of the cold storage pack in accordance with a shape of the object; enwrapping the object in the cold storage pack, in which the easy cutting section has been cut, in a direction around a first imaginary axis and in a direction around a second imaginary axis, where the first imaginary axis runs through the object and the second imaginary axis is perpendicular to the first imaginary axis; and placing the object enwrapped in the cold storage pack into the container.

### Advantageous Effects of Invention

The present invention, in an aspect thereof, provides a cold storage pack, a packaging container, and a method of transporting an object at low temperature, each enabling isothermal transport without much labor and cost.

### BRIEF DESCRIPTION OF DRAWINGS

FIG. 1 is a plan view of a cold storage pack 1 in accordance with a first embodiment.

FIG. 2 is a cross-sectional view of the cold storage pack 1 in accordance with the first embodiment.

FIG. 3 is a plan view of some steps in a method of manufacturing the cold storage pack 1 in accordance with the first embodiment.

FIG. 4 is a cross-sectional view of a cold storage pack 1A in accordance with a second embodiment.

FIG. 5 is a perspective view of a packaging container 100 in accordance with the present embodiment.

FIG. 6 is a cross-sectional view of another variation example of the packaging container 100.

FIG. 7 is a perspective view of a variation example of a method of transporting an object at low temperature in accordance with the present embodiment.

FIG. 8 is a perspective view of a variation example of the method of transporting an object at low temperature in accordance with the present embodiment.

FIG. 9 is a cross-sectional view of a packaging container used in Example 1.

FIG. 10 is a cross-sectional view of a packaging container used in Comparative Example 1.

FIG. 11 is a graph representing temperature changes in objects X to be kept cold and in cold storage packs in accordance with Example 1 and Comparative Example 1.

### DESCRIPTION OF EMBODIMENTS

### Cold Storage Pack

### First Embodiment

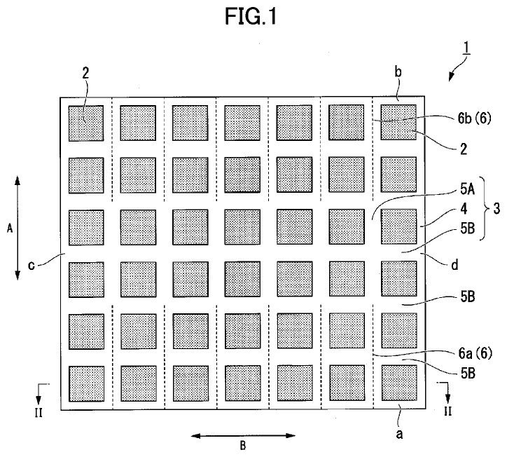

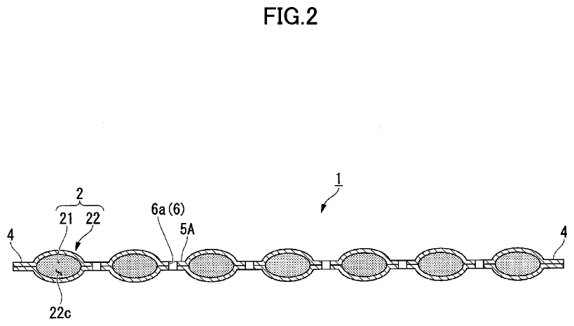

The following will describe a cold storage pack in accordance with a first embodiment of the present invention with reference to FIGS. 1 and 2. Elements shown in the drawings introduced below may be drawn with different dimensions and proportions where appropriate for easy recognition of the elements.

FIG. 1 is a plan view of a cold storage pack 1 in accordance with the first embodiment. FIG. 2 is a cross-sectional view of the cold storage pack 1 in accordance with the first embodiment. The cross-sectional view in FIG. 2 is taken along line II-II shown in FIG. 1.

The cold storage pack 1 is wrapped around an object to be kept cold. The object to be kept cold may be anything from medicine to cells, blood and other like specimens, and food.

The cold storage pack 1 includes a plurality of heat exchange sections 2 and a connecting section 3 for connecting adjacent heat exchange sections 2 together.

### Heat Exchange Sections

The heat exchange sections 2 are arranged, like a two dimensional matrix, in a first direction A and in a second direction B that intersects with the first direction A. The first direction A and the second direction B are perpendicular in the cold storage pack 1 in accordance with the present embodiment. The first direction A and the second direction B do not necessarily form an angle of 90°.

There are provided six heat exchange sections 2 in the first direction A and seven heat exchange sections 2 in the second direction B in the cold storage pack 1 in accordance with the present embodiment. The number of heat exchange sections 2 provided in the first direction A and the number of heat exchange sections 2 provided in the second direction B are not limited to this example.

Referring to FIG. 2, each heat exchange section 2 includes a latent heat storage material 21 and a container section 22.

The latent heat storage material 21 may be any commonly known substance. The latent heat storage material 21 may be, for example, water or a water-containing material.

The water-containing material may be, for example, a semi-clathrate hydrate of a C₁-C₆ quaternary alkyl salt, a clathrate hydrate of an organic compound having a molecular weight of 200 or less, an aqueous inorganic salt solution, or an inorganic salt hydrate.

A clathrate hydrate is a crystallized compound of a basket-like clathrate lattice formed by the hydrogen bonds of water molecules (host molecules), the basket-like clathrate lattice holding in a cavity thereof guest molecules of a relatively small molecular size (molecular weight of 200 or less) such as tetrahydrofuran or cyclohexane. Meanwhile, a semi-clathrate hydrate is a crystallized compound of a basket-like clathrate lattice formed by the hydrogen bonds of water molecules (host molecules), the basket-like clathrate lattice enwrapping therein a guest molecule of a relatively large molecular size such as a tetraalkylammonium cation in such a manner as to circumvent the alkyl chain of the tetraalkylammonium cation. The basket-like clathrate lattice formed by the hydrogen bonds of a semi-clathrate hydrate enwraps therein a guest molecule of a relatively large molecular size as described here. Unlike the basket-like clathrate lattice formed by the hydrogen bonds of water molecules, the basket-like clathrate lattice formed by the hydrogen bonds of a semi-clathrate hydrate is therefore partially broken when the basket-like clathrate lattice crystallizes. The crystal is hence called a semi-clathrate hydrate.

Throughout the following description, the “clathrate hydrate” includes the “semi-clathrate hydrate.”

Examples of the C₁-C₆ quaternary alkyl salt include tetrabutylammonium fluoride, tetrabutylammonium chloride, tetrabutylammonium bromide, tetrabutylammonium iodide, tetrabutylammonium nitrate, tetrabutylammonium benzoate, tributylpentylammonium bromide, and tetrabutylphosphonium bromide.

Examples of the organic compound having a molecular weight of 200 or less include tetrahydrofuran, dioxane, cyclopentane, cyclohexane, and acetone.

Examples of the inorganic salt in the aqueous inorganic salt solution include sodium chloride, potassium chloride, and ammonium chloride.

Examples of the inorganic salt hydrate include sodium acetate trihydrate and sodium sulfate decahydrate.

The latent heat storage material 21 may alternatively be a material containing an organic compound as a base material. The “material containing an organic compound as a base material” in the present embodiment refers to a material containing an organic compound that accounts for the largest mass fraction of all the components. The “material containing an organic compound as a base material” preferably contains, for example, at least 90 mass % organic compound. The material containing an organic compound as a base material may contain, for example, preservatives, antibacterial agents, thickening agents, solvents, dyes, and supercooling-restraining additives detailed later, in addition to the organic compound.

The material containing an organic compound as a base material may be, for example, a C₁₃-C₃₀ straight chain alkane, a C₁₃-C₂₀ straight chain alkyl alcohol, a polyethylene glycol with a molecular weight of 400 to 800, or a C₁₀-C₁₄ straight chain fatty acid.

The latent heat storage material 21 is preferably a material with a high latent heat value. The latent heat storage material 21 is also preferably a material that has a primary onset temperature of melting or solidification that falls in a temperature range suitable for the transport of medicine (2 to 8° C.) or fresh produce (8 to 15° C.). Examples of the material containing an organic compound as a base material and exhibiting such properties include tetradecane, pentadecane, and hexadecane.

That organic compound preferably contains a gelling agent for the benefit of manufacturing or transport.

In the present embodiment, the latent heat storage material 21 is more preferably a non-combustible material such as water or the water-containing material described above.

These materials may be mixed in any proportion for use. The primary onset temperature of melting or solidification can be adjusted by mixing these materials.

The “onset temperature of melting” in the present specification refers to the temperature at which the latent heat storage material starts melting. The “onset temperature of solidification” in the present specification refers to the temperature at which the latent heat storage material starts solidifying.

The “primary onset temperature of melting” in the present specification refers to one of the onset temperatures of melting at which the material exhibits the largest latent heat value. As an example, suppose that a measurement shows that a latent heat storage material has two onset temperatures of melting. If the latent heat storage material exhibits latent heat values of A J/g and B J/g (A>B) respectively at the onset temperatures of melting, the onset temperature of melting at which the latent heat storage material exhibits the latent heat value of A J/g is the “primary onset temperature of melting” in the present specification.

When a measurement shows that a latent heat storage material has three or more onset temperatures of melting, the latent heat values at the three or more onset temperatures of melting are compared. The onset temperature of melting at which the latent heat storage material exhibits the largest latent heat value is the “primary onset temperature of melting.”

The latent heat storage material 21 may contain an additive for the purpose of restraining supercooling of water, the clathrate hydrate, the aqueous inorganic salt solution, and the inorganic salt hydrate. The “additive for the purpose of restraining supercooling” may be referred to as the supercooling inhibitor in the following description.

The supercooling inhibitor promotes the nucleation of the latent heat storage material 21. When the supercooling inhibitor is soluble in water, and the aqueous solution of the supercooling inhibitor is cooled, the aqueous solution saturates, causing undissolved components to precipitate in crystal form. This is how the supercooling inhibitor promotes the nucleation of the latent heat storage material 21.

Examples of supercooling inhibitors that are soluble in water include inorganic salts such as potassium alum, ammonium alum, sodium carbonate, and disodium hydrogen phosphate.

The supercooling inhibitor may be prepared in powder form that is poorly soluble or insoluble in the latent heat storage material. Examples of such powder include activated carbon, aluminum oxide, titanium oxide, silver iodide, sodium tetraborate, and silicon dioxide.

The latent heat storage material 21 may contain, for example, preservatives, antibacterial agents, thickening agents, solvents, dyes, and/or other additives.

The melting point of the latent heat storage material 21 is adjusted by changing, for example, the composition of the latent heat storage material 21, so that the melting point gives a temperature suitable for the cooling of an object.

The “temperature suitable for the cooling” is said to be from 0° C., exclusive, to 15° C., inclusive, for fresh produce, from 0° C., exclusive, to 10° C., inclusive, for dairy products such as milk and refrigerated foods such as ham and other processed foods, and from 2° C. to 8° C., both inclusive, for medicine.

The melting point of the latent heat storage material 21 is lower than room temperature. The melting point of the latent heat storage material 21 does not necessarily have a particular lower limit and may be, for example, higher than the lowest temperature at which the resin film (detailed later) making up the container section 22 and the connecting section 3 is not degraded.

“Room temperature” as used in the present specification is a scientific term and refers, for example, to 25° C.

The container section 22 has therein an internal space 22c containing the latent heat storage material 21 in a liquid-tight manner. The container section 22 has an elliptic cross-section in FIG. 2, but may have a different cross-sectional shape.

### Connecting Section

Referring to FIG. 1, the connecting section 3 includes a frame-shaped section 4, first connecting sections 5A, and second connecting sections 5B.

The frame-shaped section 4 surrounds the individual heat exchange sections 2.

Each first connecting section 5A extends in the first direction A between a different pair of adjacent heat exchange sections 2.

Each second connecting section 5B extends in the second direction B between a different pair of adjacent heat exchange sections 2.

The intersections of the first connecting sections 5A and the second connecting sections 5B may be referred to as either the first connecting sections 5A or the second connecting sections 5B.

The cold storage pack 1 bends along the first connecting sections 5A and the second connecting sections 5B. This structure enables the cold storage pack 1 to be placed in contact with, or in proximity to, an object to be kept cold even when the latent heat storage material 21 is frozen.

The connecting section 3 includes, between each pair of adjacent heat exchange sections 2, an easy cutting section 6 such that the heat exchange sections 2 can be disconnected from each other. This allows manually and easily tearing the connecting section 3 apart without using a tool. In addition, there is low risk of the latent heat storage material 21 leaking out of the cold storage pack 1 because the connecting section 3 is cut which contains no latent heat storage material 21 therein.

The easy cutting section 6 is continuous from the outer periphery of the frame-shaped section 4 partway through the first connecting section 5A. More specifically, the easy cutting section 6 is provided from one of the ends (end “a”) of the first connecting section 5A partway through the first connecting section 5A and from the other end “b” of the first connecting section 5A partway through the first connecting section 5A. There exists a gap separating a easy cutting section 6a extending from the end “a” of the first connecting section 5A and a easy cutting section 6b extending from the end “b” of the first connecting section 5A.

The easy cutting section 6 in the connecting section 3 may be cut all through the length thereof and may be cut from the outer periphery of the frame-shaped section 4 partway through the easy cutting section 6. The easy cutting section 6 is cut all the way to the intersection of the first connecting section 5A and the second connecting section 5B.

The easy cutting sections 6 are lines of perforations in FIG. 1. “A line of perforations” in the present specification is an array of holes formed along an imaginary line running from the outer periphery of the frame-shaped section 4 partway through the first connecting section 5A.

The easy cutting section 6 may be of a “half-cut” type.

The connecting section 3 preferably includes a reconnecting section in locations where the easy cutting sections 6 are provided, to enable reconnecting the connecting section 3 that has been cut along the easy cutting sections 6. The reconnecting section is not limited in any particular manner and may be a hook and loop fastener provided across both sides of the easy cutting section 6 in the connecting section 3. The connecting section 3 may alternatively include a mutually engageable segment on both sides of the easy cutting section 6 in the connecting section 3. As a further alternative, the connecting section 3 may include holes on one of the sides of the easy cutting section 6 in the connecting section 3 and hooks that go into the holes on the other side thereof.

The cold storage pack 1 may, in a variation example thereof, include an easy cutting section that is continuous from the end “a” to the end “b” of the first connecting section 5A. This structure enables adjusting the length of the part of the connecting section cut along the easy cutting section in accordance with the size of the object to be kept cold when the object is enclosed in the cold storage pack.

The cold storage pack 1 may, in another variation example thereof, include an easy cutting section only from the end “a” of the first connecting section 5A partway through the first connecting section 5A. This structure saves labor in forming the easy cutting section in the manufacture of the cold storage pack and still enables isothermal transport. This variation example of the cold storage pack can cover the top and all around the side surface of an object to be kept cold.

The cold storage pack 1 may, in a further variation example thereof, include an easy cutting section that is continuous from the outer periphery of the frame-shaped section 4 partway through the second connecting section 5B.

More specifically, the easy cutting section may be provided from one of the ends (end “c”) of the second connecting section 5B partway through the second connecting section 5B and from the other end “d” of the second connecting section 5B partway through the second connecting section 5B. This structure enables the cold storage pack, when divided along the easy cutting sections, to enclose therein an object to be kept cold regardless of the posture of the object.

Alternatively, the easy cutting section may be continuous from one of the ends (end “c”) of the second connecting section 5B to the other end “d” of the second connecting section 5B.

This structure enables adjusting the length of the part of the connecting section cut along the easy cutting section in accordance with the size of the object to be kept cold when the object is enclosed in the cold storage pack.

As another alternative, the easy cutting section may be provided only from the end “c” of the second connecting section 5B partway through the second connecting section 5B. This structure saves labor in forming the easy cutting section in the manufacture of the cold storage pack and still enables isothermal transport.

The connecting section 3 may include any one of these types of easy cutting sections 6 and may include a combination of any two or more of these types of easy cutting sections 6.

If the cold storage pack 1 includes no easy cutting sections 6, the cold storage pack 1 is bent along either the first connecting sections 5A or the second connecting sections 5B when the cold storage pack 1 is used to enclose an object to be kept cold therein. The cold storage pack 1 however leaves the object exposed out of the cold storage pack when viewed along the one of the connecting sections that is bent.

In contrast, the cold storage pack 1 in accordance with the present embodiment can be bent along the second connecting sections 5B that correspond to the cut parts of the easy cutting sections 6a. This mechanism enables the cold storage pack 1 to assume a three-dimensional structure. The “three-dimensional structure assumed by the cold storage pack 1” is a container-like structure formed by a face on one end of an axis running through an object to be kept cold and a face around the axis. The shape of the three-dimensional structure and the dimensions of the internal space therein can be changed by changing the locations to be cut by the easy cutting sections 6.

The container sections 22 and the connecting section 3 are made of a resin film. In the present embodiment, thermocompression is carried out only on parts of a resin film to form the connecting section 3, which leaves the other parts of the resin film between the connecting section 3 undergoing no thermocompression as the container sections 22. Therefore, the resin contained in the resin film can be thermocompression bonded. Further, the resin is a material that the latent heat storage material 21 from leaking out and volatilizing. The resin also imparts flexibility to the connecting section 3.

Preferred examples of such a resin include polyethylene, polypropylene, polyamide, and polyester. Any one of these resins may be used alone. Alternatively, two or more of them may be used in any combination.

The resin film may include a single layer or a plurality of layers.

The cold storage pack 1 may include a thin film of aluminum or silicon dioxide covering the resin film for enhanced durability and barrier properties. The resin film may have attached thereto a temperature-sensitive sticker made of a thermochromic substance so that a user can know of the temperature of the cold storage pack 1.

The resin film may further have the exterior thereof covered with an additional film for improvement of the physical strength, texture, and thermal insulation properties of the cold storage pack 1.

Method of Manufacturing Cold Storage Pack

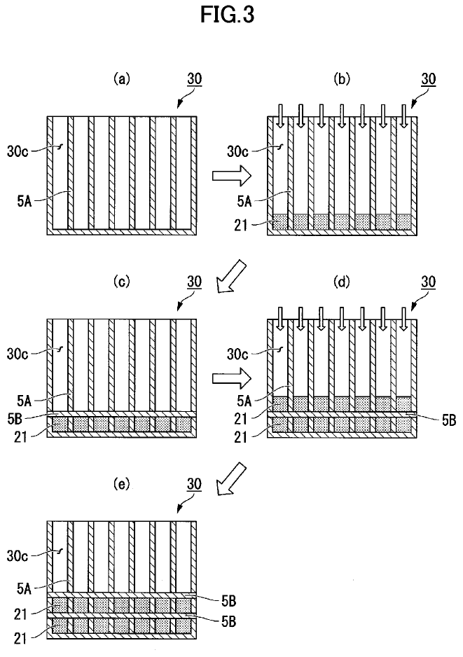

A description is now given of an exemplary method of manufacturing the cold storage pack 1 with reference to FIG. 3. FIG. 3 is a plan view of some steps in a method of manufacturing the cold storage pack 1 in accordance with the first embodiment. The up/down direction in FIG. 3 corresponds to the first direction A in FIG. 1 and matches with the gravity direction, and the horizontal direction in FIG. 3 corresponds to the second direction B in FIG. 1.

First, as shown in (a) of FIG. 3, a tubular film 30 with an open end is subjected to thermocompression in such a manner as to close the tubular film 30 from top to bottom along a plurality of vertically elongated portions thereof separated by prescribed horizontal intervals, to form the first connecting sections 5A. This step forms an intermediate member that has a horizontal array of strip-shaped internal spaces 30c.

Next, as shown in (b) of FIG. 3, a prescribed, equal amount of the latent heat storage material 21 is injected into each strip-shaped internal space 30c in the tubular film 30 using a pump or like publicly known means. The latent heat storage material 21 is fed in the gravity direction so that the latent heat storage material 21 can be easily injected into the internal spaces 30c.

Next, as shown in (c) of FIG. 3, the tubular film 30, with the internal spaces 30c now containing a prescribed amount of the latent heat storage material 21, is subjected to thermocompression in such a manner as to close the tubular film 30 from side to side along a horizontally elongated portion thereof at prescribed intervals, to form one of the second connecting sections 5B.

Next, as shown in (d) of FIG. 3, a prescribed amount of the latent heat storage material is again injected into each remaining strip-shaped internal space 30c located directly above the resultant second connecting section 5B at the same rate using a pump or like publicly known means.

Next, as shown in (e) of FIG. 3, the tubular film 30, with the remaining internal spaces 30c now containing a prescribed amount of the latent heat storage material 21, is subjected to thermocompression in such a manner as to close the tubular film 30 from side to side along a horizontally elongated portion thereof at the prescribed intervals, to form another one of the second connecting sections 5B.

The steps shown in (d) and (e) of FIG. 3 are repeated from the other end to one end of the tubular film 30, to form a matrix of heat exchange sections 2.

After the matrix of heat exchange sections 2 is formed, the easy cutting sections 6 are formed by a publicly known means from the end “a” of the first connecting section 5A partway through the first connecting section 5A and from the end “b” of the first connecting section 5A partway through the first connecting section 5A. This step concludes the manufacture of the cold storage pack 1 complete with the heat exchange sections 2 and the connecting section 3.

The cold storage pack in accordance with an aspect of the present invention is not necessarily manufactured by the method described here. Alternatively, the cold storage pack in accordance with an aspect of the present invention may be manufactured, as an example, by first placing a resin film on a metal mold that has grooves, next vacuum-molding or pressing the resin film to form a housing member, then injecting a predetermined amount of the latent heat storage material 21 in the liquid state into concave sections of the housing member using, for example, a pump, placing a sealing member on the housing member, and finally firmly attaching the sealing member to the housing member by thermocompression.

### Second Embodiment

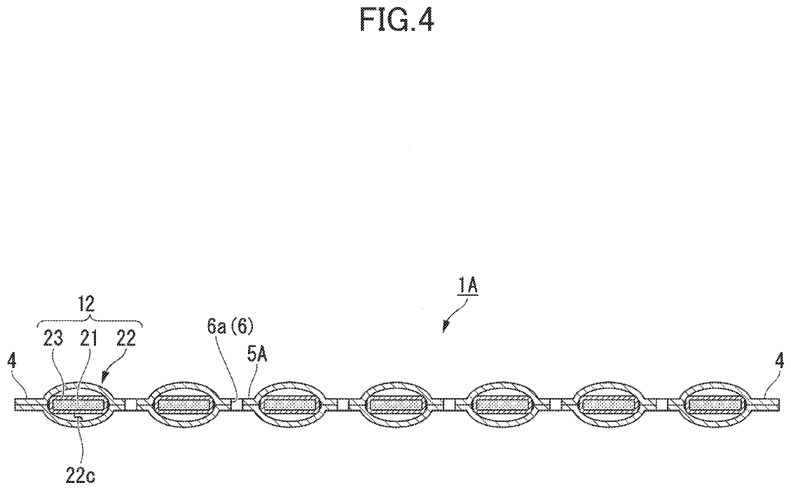

FIG. 4 is a cross-sectional view of a cold storage pack 1A in accordance with a second embodiment. FIG. 4 is associated with FIG. 2. The cold storage pack 1A in accordance with the present embodiment and the cold storage pack 1 in accordance with the first embodiment have some common elements. Members of the present embodiment that are the same as those in the first embodiment are indicated by the same reference signs or numerals, and detailed description thereof is omitted.

Referring to FIG. 4, the cold storage pack 1A includes a plurality of heat exchange sections 12 and a connecting section 3 for connecting adjacent heat exchange sections 12 together.

Each heat exchange section 12 includes a latent heat storage material 21, a container section 22, and an internal container 23. The internal container 23 is housed in an internal space 22c of the container section 22.

The internal container 23 is hollow and contains the latent heat storage material 21 therein. The internal container 23 is preferably made of a resin material such as polyethylene, polypropylene, polyamide, or polyester.

In the present embodiment, even if the container sections 22 are damaged, there is low risk of the latent heat storage material 21 leaking out of the cold storage pack 1 because the latent heat storage material 21 is contained in the internal containers 23. The cold storage pack 1A in accordance with the present embodiment is therefore is more reliable than the cold storage pack 1 in accordance with the first embodiment.

Method of Manufacturing Cold Storage Pack

The cold storage pack 1A is manufacturable by publicly known technology. First, the internal containers 23 are prepared that contain the latent heat storage material 21. Next, the internal containers 23 containing the latent heat storage material 21 are placed in a tubular film. The tubular film is then subjected to thermocompression similarly to the cold storage pack 1. The easy cutting sections 6 are then formed by publicly known apparatus from the end “a” of the first connecting section 5A partway through the first connecting section 5A and from the end “b” of the first connecting section 5A partway through the first connecting section 5A, which concludes the manufacture of the cold storage pack 1A complete with the heat exchange sections 12 and the connecting section 3.

Packaging Container

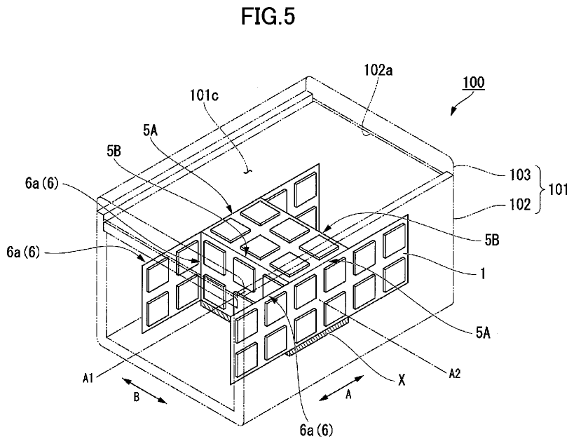

FIG. 5 is a perspective view of a packaging container 100 in accordance with the present embodiment. Referring to FIG. 5, the packaging container 100 includes the cold storage pack 1 shown in FIGS. 1 and 2 and a container 101. FIG. 5 shows a rectangular parallelepiped article as an object X to be kept cold.

The container 101 includes a main section 102 and a lid section 103.

The container 101 has an internal space 101c to accommodate an object X to be kept cold therein. The internal space 101c is surrounded by the main section 102 and the lid section 103.

The main section 102 has an opening 102a through which the object X and the cold storage pack 1 are put into, and taken out of, the container 101. The main section 102 is preferably made of a thermally insulating material such as styrene foam, urethane foam, or a vacuum insulation material. Alternatively, the main section 102 may include: a main body made of a material that may and may not be thermally insulating; and a thermal insulation layer of a thermally insulating material disposed inside or outside the main body.

The main section 102 may include on the side or bottom surface thereof a fixing section for fixing the cold storage pack 1.

The lid section 103 closes the opening 102a. The lid section 103 is made of one of the materials listed as materials for the main section 102. The lid section 103 may be made of the same material as the main section 102 and may be made of a different material from the main section 102.

The main section 102 and the lid section 103 may be either coupled or separated. The lid section 103 is preferably structured so as to tightly seal the main section 102 in order to restrict the flow of heat into and out of the packaging container 100.

The packaging container 100 may include a thermal insulation member above the cold storage pack 1 for enhanced cold insulation capability.

The packaging container 100 may, in a variation example thereof, include the cold storage pack 1A shown in FIG. 4 in place of the cold storage pack 1. The packaging container 100 may, in another variation example thereof, include a combination of the cold storage pack 1 and the cold storage pack 1A.

The packaging container 100 may, in a further variation example thereof, include a commonly known cold storage pack in addition to either one or both of the cold storage pack 1 and the cold storage pack 1A.

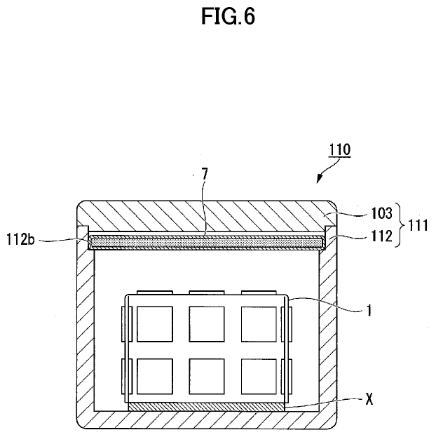

FIG. 6 is a cross-sectional view of still another variation example of the packaging container 100. Referring to FIG. 6, a packaging container 110 includes a cold storage pack 1, a publicly known cold storage pack 7, and a container 111.

The container 111 includes a main unit 112 and a lid section 103. The main unit 112 includes a holder section 112b for holding the cold storage pack 7. The holder section 112b is formed by cutting out the upper ends of the main unit 112. The holder section 112b is provided on the opposing upper ends of the main unit 112. The holder section 112b may be provided on the upper ends of the main unit 112 all around the main unit 112.

The cold storage pack 7 may contain the same latent heat storage material as does the cold storage pack 1 and may contain a different latent heat storage material than does the cold storage pack 1. The latent heat storage material in the cold storage pack 7 preferably has a higher melting point than the melting point of the latent heat storage material in the cold storage pack 1.

Temperature rises inside the container 111 during transport of the object X that involves the use of the packaging container 110. The temperature rise inside the container 111 reduces the cold insulation capability of the packaging container 110. If the latent heat storage material in the cold storage pack 7 has a higher melting point than the melting point of the latent heat storage material in the cold storage pack 1, the latent heat storage material in the cold storage pack 7 melts later than the latent heat storage material in the cold storage pack 1. Therefore, temperature is restrained from rising inside the container 111 while the latent heat storage material in the cold storage pack 7 is melting. The use of the cold storage pack 1 in combination with this cold storage pack 7 hence better maintains the cold insulation capability of the packaging container 110.

Method of Transporting Object at Low Temperature

A description is now given of a method of transporting an object at low temperature in the packaging container 100. A method of transporting an object at low temperature in accordance with the present embodiment includes the step of dividing the cold storage pack 1 along the easy cutting sections 6, the step of enwrapping the object X in the cold storage pack 1 divided along the easy cutting sections 6, and the step of placing the object X enwrapped in the cold storage pack 1 into the container 101.

In the step of dividing the cold storage pack 1 along the easy cutting sections 6, the easy cutting sections 6 are cut in accordance with the shape of the object X. In FIG. 5, the easy cutting sections 6a extending from the end “a” of the first connecting sections 5A are cut.

Now, assume a first imaginary axis A1 running through the object X and a second imaginary axis A2 perpendicular to the first imaginary axis A1, to describe the step of enwrapping the object X. The direction of the first imaginary axis A1 matches the first direction A shown in FIG. 1, and the direction of the second imaginary axis A2 matches the second direction B shown in FIG. 1. In the step of enwrapping the object X, the object X is enwrapped in the cold storage pack 1, in which some of the easy cutting sections 6 are cut, both in the direction around the first imaginary axis A1 and in the direction around the second imaginary axis A2.

More specifically, the cold storage pack 1 is mountain-folded along two of the first connecting sections 5A where the easy cutting sections 6 remain connected. The cold storage pack 1 is also mountain-folded along two of the second connecting sections 5B where the easy cutting sections 6 are partially cut. The cold storage pack 1, when folded in this manner, provides a three-dimensional structure having a top face and four side faces. The cold storage pack 1, when the object X is placed in the internal space of the three-dimensional structure, is in contact with the top and side faces of the object X. Heat conducts through a contact surface between the object X and the cold storage pack 1, thereby cooling the object X. Heat is restrained from flowing into the object X through the top and side faces of the object X.

The object X has a bottom surface thereof in contact with the bottom face of the main section 102. For this reason, although depending on where the packaging container 100 is located, heat would be restrained from flowing into the object X through the bottom surface of the object X unless the bottom face of the main section 102 becomes very hot.

In addition, when the packaging container 100 is shaken during the transport of the object X, the folds in the cold storage pack 1 are likely to remain in contact with the object X under gravity. No tools are hence required to secure the cold storage pack 1 around the object X. The latent heat storage material 21 in the cold storage pack 1, frozen when the cold storage pack 1 is placed around the object X, can melt during the transport of the object X and is still capable of remaining in place covering the object X.

A cold storage pack with no easy cutting sections does not provide a three-dimensional structure that conforms to the shape of the object to be kept cold. A packaging container containing a single cold storage pack of this type can therefore house and cool the object, but the object and the cold storage pack are separated from each other.

In this situation, the object comes to have a higher temperature than the melting point of the latent heat storage material in the cold storage pack due to heat exchange between the cold storage pack and the air inside the container. Therefore, the latent heat storage material typically has a melting point lower than the lower limit of the temperature range in which the object should be kept.

However, because the object is placed relatively close to the cold storage pack containing a latent heat storage material that has such a melting point, the object can be cooled to a temperature lower than the lower limit of the temperature range in which the object should be kept.

In contrast, the method of transporting an object at low temperature in accordance with the present embodiment involves heat exchange through a contact surface between the object X and the cold storage pack 1. The latent heat storage material 21 can hence have a melting point at a temperature suited to the object X. These mechanisms enable isothermal transport at a temperature close to the melting point of the latent heat storage material 21. The inventors have verified that the method in accordance with the present embodiment is capable of the isothermal transport of the object X at a temperature close to the melting point of the latent heat storage material 21 in a 35° C. environment. The method in accordance with the present embodiment is therefore suitable for the transport of medicine, which requires rigorous temperature control, and fresh produce, which can easily suffer from low-temperature damage.

The method of transporting an object at low temperature in accordance with the present embodiment does not need a large number of cold storage packs and ensures a sufficient volume for accommodating an object in the packaging container. In other words, the method of transporting an object at low temperature in accordance with the present embodiment does not require much labor and cost.

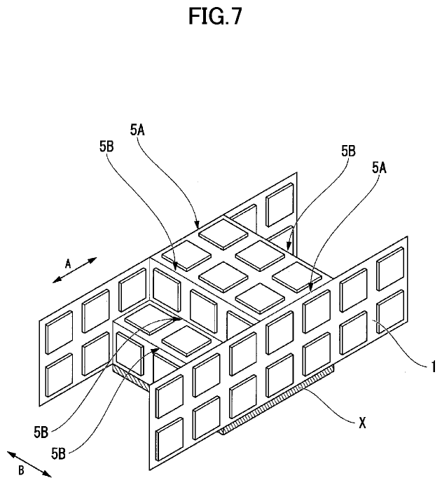

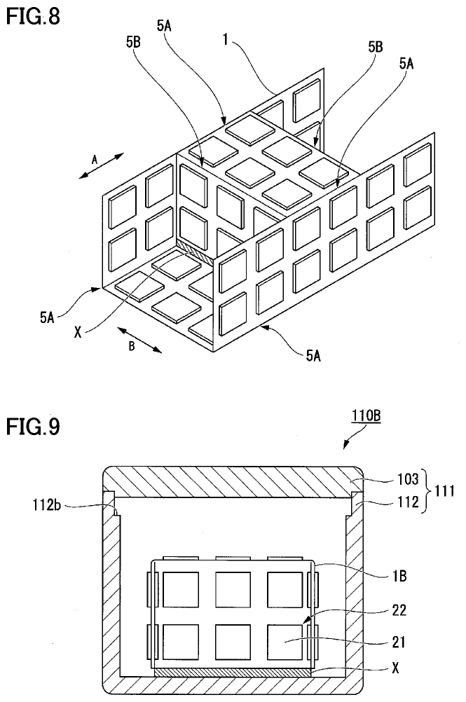

The object X to which the method of transporting in accordance with the present embodiment is applied is not necessarily a rectangular parallelepiped. FIGS. 7 and 8 are perspective views of variation examples of the method of transporting an object at low temperature in accordance with the present embodiment. The drawings introduced below show no container 101 for clarity of description.

FIG. 7 illustrates an object X to be transported at low temperature, the object X being shaped like two rectangular parallelepiped blocks of different heights coupled together. First, the cold storage pack 1 is mountain-folded along two of the first connecting sections 5A where the easy cutting sections 6 remain connected. The cold storage pack 1 is also mountain-folded along one of the second connecting sections 5B where those easy cutting sections 6 located in the back are partially cut. The cold storage pack 1 is then mountain-folded and valley-folded alternately along three of the second connecting sections 5B where those easy cutting sections 6 located in the front are partially cut. The cold storage pack 1, when folded in this manner, provides a three-dimensional structure having a top face and four side faces. The cold storage pack 1, when the object X is placed in the internal space of the three-dimensional structure, is in contact with the top and side faces of the object X. These mechanisms enable the isothermal transport of the object X illustrated in FIG. 7. The mechanisms illustrated in FIG. 7 work also in the transport of a plurality of objects X with different heights.

To enable the cold storage pack 1 to fit an object X that has a more complex shape, the cold storage pack 1 preferably includes container sections 22 that have a smaller area in a plan view.

FIG. 8 illustrates the transport of an object X to be kept cold in a high-temperature environment, for example, in summer or in tropical regions. In such cases, the bottom surface of the main section 102 will likely reach a high temperature. This problem is addressed by additionally covering the bottom surface of the object X with the cold storage pack 1 to restrain heat from flowing into the object X through the bottom surface. More specifically, the cold storage pack 1 is mountain-folded along two more of the first connecting sections 5A as well as along those connecting sections for the case shown in FIG. 5. The cold storage pack 1, when folded in this manner, provides a three-dimensional structure having no open face. The cold storage pack 1, when the object X is placed in the internal space of the three-dimensional structure, is in contact with all the faces of the object X. These mechanisms enable the isothermal transport of the object X even in a high-temperature environment.

### EXAMPLES

The following will describe the present invention by way of examples. The present invention is not limited by these examples. The following description will use the same reference signs or numerals as those used in the foregoing embodiments where appropriate.

Melting Point of Latent Heat Storage Material

In the present examples of the invention, the melting points of latent heat storage materials were determined from a DSC curve obtained by differential scanning calorimetry (DSC) using a differential scanning calorimeter (DSC 8231, manufactured by Rigaku Corporation).

First, the thermostatic tank prepared for use in the measurement was set up for an initial temperature of −20° C. and then heated from −20° C. to 30° C. at a rate of 0.25° C./minute while measuring the amount of heat absorbed by the latent heat storage material, to obtain a DSC curve. Next, as the onset temperature of melting, a temperature was obtained by extrapolating, toward the baseline, the temperature at which one endothermic peak starts on the obtained DSC curve. The obtained onset temperature of melting was employed as the melting point of the latent heat storage material.

### Example 1

FIG. 9 is a cross-sectional view of a packaging container of Example 1. A packaging container 110B illustrated in FIG. 9 includes a cold storage pack 1B and a container 111.

The cold storage pack 1B is an equivalent of the cold storage pack 1 illustrated in FIG. 1. The cold storage pack 1B differs from the cold storage pack 1 in that the former includes seven heat exchange sections 2 in the first direction A shown in FIG. 1 and seven heat exchange sections 2 in the second direction B shown in FIG. 1.

Each container section 22 measures 60 mm in length, 60 mm in width, and 15 mm in height. The height of the container section 22 refers to the height of the highest part of the container section 22.

The latent heat storage material 21 has a total mass of 1.2 kilograms and a melting point of 7° C.

The container 111 is made of styrene foam and has an internal space of 17 L.

The main unit 112 internally measures 330 mm in length, 260 mm in width, and 200 mm in height. The internal length and internal width of the main unit 112 refer to the length and width of the bottom face of the main unit 112 respectively.

The lid section 103 measures 375 mm in length, 300 mm in width, and 30 mm in height. The length and width of the lid section 103 refer to the length and width of the top face of the lid section 103 respectively.

An object X was prepared to be kept cold in a rectangular parallelepiped measuring 200 mm in length, 180 mm in width, and 145 mm in height. First, the cold storage pack 1B was divided along easy cutting sections. Next, the object X was enwrapped in the cold storage pack 1B thus divided by the method described above with reference to FIG. 5. Next, the object X, enwrapped in the cold storage pack 1B, was placed at the center of the bottom face of the container 111. The cold storage pack 1B hence came into contact with the surroundings of the object X, thereby cooling the object X.

### Example 2

An object X similar to the one used in Example 1 was prepared and cooled in Example 2. Example 2 differs from Example 1 in the type of the latent heat storage material 21 in the packaging container 110B. The latent heat storage material 21 used in Example 2 was silicon dioxide (supercooling inhibitor) dispersed in water. The addition ratio of silicon dioxide relative to water was 0.1 mass %.

### Comparative Example 1

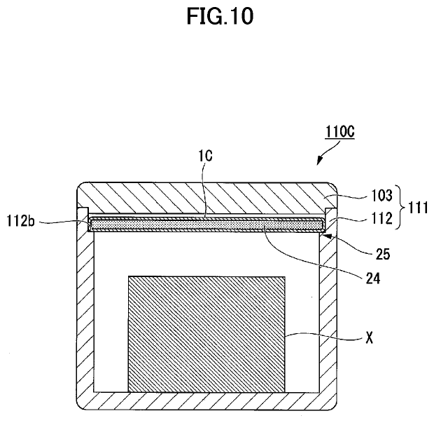

FIG. 10 is a cross-sectional view of a packaging container used in Comparative Example 1. A packaging container 110C illustrated in FIG. 10 differs from the packaging container 110B illustrated in FIG. 9 in the type and location of a cold storage pack 1C.

The cold storage pack 1C contains a latent heat storage material 24 in a platelike container section 25. The container section 25 measures 320 mm in length, 270 mm in width, and 15 mm in height.

The latent heat storage material 24 has a total mass of 1.2 kilograms and a melting point of 0° C.

An object X similar to the one used in Example 1 was prepared. The object X was placed at the center of the bottom face of the container 111.

The cold storage pack 1C was held by the holder section 112b of the main unit 112 similarly to the cold storage pack 7 illustrated in FIG. 6. The cold storage pack 1C cools the object X from above the object X.

Evaluation Method

The cold insulation capabilities of the packaging containers of Example 1 and Comparative Example 1 were evaluated using an object to be kept cold.

First, the cold storage packs of Example 1, Example 2, and Comparative Example 1 were cooled to freeze the cold storage packs. More specifically, the cold storage pack of Example 1 was cooled at 3° C. in a refrigeration room for 24 hours, so that the cold storage pack froze. The cold storage pack of Example 2 was cooled at −5° C. in a freezer compartment for 24 hours, so that the cold storage pack froze. The cold storage pack of Comparative Example 1 was cooled at −18° C. in a freezer compartment for 24 hours, so that the cold storage pack froze.

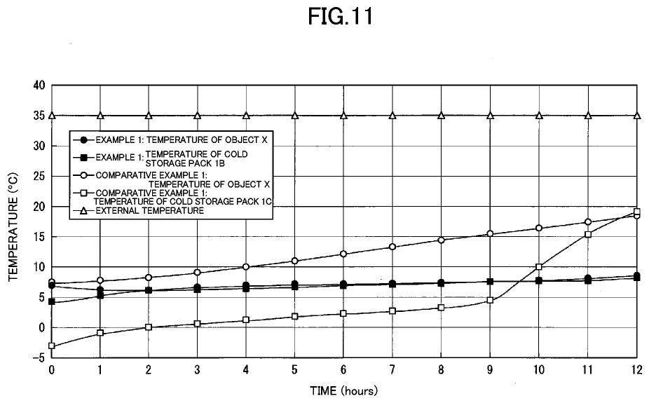

Next, the objects X and the frozen cold storage packs were placed in the respective packaging containers of Example 1, Example 2, and Comparative Example 1. The packaging containers were left in a 35° C. atmosphere for 12 hours, to log temperature changes in the objects X and the cold storage packs. Temperature was measured using a chip-type temperature logger Thermochron. Results from Example 1 and Comparative Example 1 are shown in FIG. 11.

FIG. 11 is a graph representing temperature changes in the objects X and the cold storage packs of Example 1 and Comparative Example 1. FIG. 11 demonstrates that in Example 1 the temperature of the object X and the temperature of the cold storage pack 1B were practically equal in most of the time. The temperature of the object X remained in the range of 7 to 9° C. throughout the 0 to 12 hour period.

This would be a result of the object X substantially directly exchanging heat with the cold storage pack 1B because the cold storage pack 1B, to which an aspect of the present invention is applied, was wrapped around the object X therein. That would also be a result of the temperature of the object X being successfully less affected by the air inside the packaging container 110B for the same reason. This evaluation demonstrates that the packaging container 110B of Example 1 is capable of isothermal transport at a temperature close to the melting point of the latent heat storage material 21.

On the other hand, in Comparative Example 1, the temperature of the object X and the temperature of the cold storage pack 1B gradually rose with time. The evaluation demonstrates that the packaging container 110C of Comparative Example 1 is incapable of isothermal transport.

Meanwhile, silicon dioxide was used as a supercooling inhibitor in Example 2 as described earlier. When water is used alone as the latent heat storage material, it is typically necessary to cool at approximately −18° C. in a freezer compartment to freeze water to change phase to ice with good reproducibility. The latent heat storage material of Example 2, containing a mixed supercooling inhibitor of water and silicon dioxide, froze with good reproducibility when cooled in a −5° C. environment.

The logging of the temperature of the object X in Example 2 shows that the object X was maintained at a temperature close to the melting point of ice (0° C.), which demonstrates that the configuration of Example 2 is capable of isothermal transport at a temperature close to 0° C.

In other words, the configuration of Example 2 is suitable for the transport of meat and fish, which requires isothermal transport at a temperature close to 0° C.

It is hence concluded that the present invention is useful.

1. A cold storage pack comprising:
a plurality of heat exchange sections arranged in a first direction and in a second direction as in a matrix, the second direction intersecting with the first direction; and
a connecting section connecting the adjacent heat exchange sections each other, wherein
the heat exchange sections each comprise:
a latent heat storage material having a melting point lower than room temperature; and
a container section having therein an internal space containing the latent heat storage material in a liquid-tight manner,
the connecting section comprises:
an easy cutting section that is cuttable between the adjacent heat exchange sections;
a frame-shaped section surrounding a periphery of a whole of the plurality of heat exchange sections;
a first connecting section extending between the adjacent heat exchange sections in the first direction; and
a second connecting section extending between the adjacent heat exchange sections in the second direction, and
the easy cutting section is continuous at least from an outer periphery of the frame-shaped section partway through the first connecting section.

2. The cold storage pack according to claim 1, wherein the easy cutting section extends from one end of the first connecting section partway through the first connecting section and from the other end of the first connecting section partway through the first connecting section.

3. The cold storage pack according to claim 1, wherein the easy cutting section extends continuously from one end of the first connecting section to the other end of the first connecting section.

4. The cold storage pack according to claim 1, wherein the easy cutting section extends from the outer periphery of the frame-shaped section partway through the second connecting section.

5. The cold storage pack according to claim 4, wherein the easy cutting section extends from one end of the second connecting section partway through the second connecting section and from the other end of the second connecting section partway through the second connecting section.

6. The cold storage pack according to claim 4, wherein the easy cutting section extends continuously from one end of the second connecting section to the other end of the second connecting section.

7. The cold storage pack according to claim 1, wherein the connecting section comprises a reconnecting section in a location where the easy cutting section is provided, the reconnecting section having been configured to reconnect the connecting section cut along the easy cutting section.

8. A packaging container comprising:
the cold storage pack according to claim 1 to enwrapping an object to be kept cold; and
a container configured to contain the object and the cold storage pack.

9. A method of transporting the object to be kept cold by using the packaging container according to claim 8, the method comprising:
cutting the easy cutting section of the cold storage pack in accordance with a shape of the object;
enwrapping the object in the cold storage pack, in which the easy cutting section has been cut, in a direction around a first imaginary axis and in a direction around a second imaginary axis, where the first imaginary axis runs through the object and the second imaginary axis is perpendicular to the first imaginary axis; and
placing the object enwrapped in the cold storage pack into the container.
